(19) United States
(12) Patent Application Publication
(10) Pub. No.: US 2020/0187321 A1
(43) Pub. Date: Jun. 11, 2020

(54) Wireless Module Holder for a Light Fixture

(71) Applicant: ABL IP Holding LLC, Atlanta, GA (US)

(72) Inventors: Prashank Kansal, Norcross, GA (US); Forrest Starnes McCanless, Oxford, GA (US)

(21) Appl. No.: 16/216,189

(22) Filed: Dec. 11, 2018

(51) Int. Cl. H05B 37/02; F21V 17/10; F21V 15/01

(52) U.S. Cl. CPC H05B 37/0272; F21V 15/01; F21V 17/10

(57) ABSTRACT

A wireless holder for a light fixture includes a base and a housing removably attached to the base. The housing defines a chamber that is configured to receive a wireless module. The wireless holder may define a gap between the base and the housing when the housing is removably attached to the base. The housing may include a module holder that is movably connected to the housing and is configured to selectively retain the wireless module within the chamber.

### FIELD OF THE INVENTION

This application relates to light fixtures and retrofit kits for light fixtures, and, more particularly, to light fixtures and retrofit kits with a wireless module holder.

### BACKGROUND

Many traditional light fixtures are not “smart” enabled, meaning that they are not connected to other devices or networks via different wireless protocols (e.g., Bluetooth®, Wi-Fi®, near field communication, LiFi, 3G, etc.) and as such cannot operate interactively and/or autonomously. Moreover, traditional light fixtures are often difficult to retrofit with Bluetooth or other wireless capabilities because such changes require modifying the light fixture in the field, which in most cases requires an inspector to be on site and approve the modifications. Therefore, there is still a need for a system that can provide for easy installation of a wireless communication module into a new or existing light fixture.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a wireless holder for a light fixture includes a base and a housing that is removably attached to the base. The housing defines a chamber that is configured to receive a wireless module. In some examples, the wireless holder defines a gap between the base and the housing when the housing is removably attached to the base.

In various examples, the wireless holder is configured to capture a portion of a housing of the light fixture within the gap when the housing is removably attached to the base. In certain aspects, the housing includes a plurality of spacers within the chamber. In some cases, the spacers define a mounting configuration for the wireless module. In various aspects, the wireless holder includes a module holder that is movably connected to the housing and is configured to selectively retain the wireless module within the chamber. In some examples, the module holder is movably connected to the housing through a living hinge.

In certain examples, the housing includes engagement arms, the base includes engagement notches, and the housing is removably attached to the base through engagement of the engagement arms with the engagement notches. In some cases, the wireless holder includes the wireless module. In various embodiments, the wireless module is a Bluetooth® module.

According to some embodiments, a light fixture includes a fixture housing and a wireless holder. The wireless holder is configured to house a wireless module and includes a base and a holder housing. In some examples, the wireless holder is removably attached to the fixture housing such that at least a portion of the fixture housing is between the holder housing and the base of the wireless holder.

In some examples, the light fixture assembly includes the wireless module. In various aspects, the fixture housing includes a fixture base having a light-emitting side and a non-light emitting side, and the wireless holder is removably attached to the fixture base such that the base of the wireless holder is on the non-light emitting side of the fixture base and the holder housing is on the light-emitting side of the fixture base.

In certain aspects, the light fixture assembly includes an optic and a light source. In various cases, the light source is arranged adjacent to an edge of the optic such that the light fixture assembly is an edge-lit light fixture assembly. In some examples, the light source includes at least one light emitting diode. In some embodiments, the holder housing includes a wirelessly transparent material.

According to various embodiments, a wireless holder for a light fixture includes a base and a housing removably attached to the base. The housing defines a chamber that is configured to receive a wireless module. In examples, the housing includes a module holder that is movably connected to the housing and is configured to selectively retain the wireless module within the chamber.

In certain examples, the wireless holder defines a gap between the base and the housing when the housing is removably attached to the base, and the wireless holder is configured to capture a portion of a housing of the light fixture within the gap when the housing is removably attached to the base. In various embodiments, the module holder is movably connected to the housing through a living hinge. In some aspects, the housing includes a plurality of spacers within the chamber that are configured to support the wireless module within the chamber.

In some embodiments, the base defines a wiring aperture that is configured to provide access to the chamber when the housing is removably attached to the base. In certain cases, the housing includes a wirelessly transparent material. In various examples, the wireless holder includes the wireless module. In some aspects, the wireless module is a Bluetooth® module.

According to various embodiments, a wireless holder for a light fixture includes a housing that defines a chamber that is configured to receive a wireless module. The housing includes a module holder that is movably connected to the housing and is configured to selectively retain the wireless module within the chamber.

In certain examples, the wireless holder includes a base. In various aspects, the housing is removably attached to the base. In some cases, the wireless holder defines a gap between the base and the housing when the housing is removably attached to the base. In some embodiments, wherein the wireless holder is configured to capture a portion of a fixture housing of the light fixture within the gap when the housing is removably attached to the base. In various examples, the base defines a wiring aperture that is configured to provide access to the chamber when the housing is removably attached to the base.

In certain embodiments, the housing further comprises a plurality of spacers within the chamber that are configured to support the wireless module within the chamber. In some examples, the housing includes a first side and a second side, and the first side includes an opening to the chamber, a support arm, and a guide. In various examples, the support arm is configured to overlap a portion of a fixture housing of a light fixture through an opening of the light fixture, and the guide is configured to position the wireless module relative to the opening of the light fixture.

In some embodiments, the module holder is configured to selectively extend across a length of the housing or a length of the chamber. In various embodiments, the module holder is configured to selectively extend across a width of the housing or a width of the chamber.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following Figures are illustrated to emphasize the general principles of the present disclosure. Corresponding features and components throughout the Figures can be designated by matching reference characters for the sake of consistency and clarity.

FIG. 1 is a perspective view of a wireless holder according to aspects of the current disclosure.

FIG. 2 is another perspective view of the wireless holder of FIG. 1.

FIG. 3 is a perspective view of a housing of the wireless holder of FIG. 1.

FIG. 4 is another perspective view of the housing of FIG. 3.

FIG. 5 is a side view of the housing of FIG. 3.

FIG. 6 is an end view of the housing of FIG. 3.

FIG. 7 is a perspective view of a base of the wireless holder of FIG. 1.

FIG. 8 is another perspective view of the base of FIG. 7.

FIG. 9 is a perspective view of a light fixture with the wireless holder of FIG. 1 according to aspects of the current disclosure.

FIG. 10 is an exploded assembly view of the light fixture of FIG. 9.

FIG. 11 is a top view of the light fixture of FIG. 9 with a housing cover removed.

FIG. 12 is a sectional view of the light fixture of FIG. 9.

FIG. 13 is an enlarged sectional view of a portion of the light fixture of FIG. 9 taken from detail circle 13 in FIG. 12.

FIG. 14 is a perspective view of a wireless holder according to aspects of the current disclosure.

FIG. 15 is another perspective view of the wireless holder of FIG. 14.

FIG. 16 is a perspective view of the wireless holder of FIG. 14 with a module holder in an unlocked position.

FIG. 17 is a perspective view of the wireless holder of FIG. 14 with a module holder in a locked position.

FIG. 18 is a perspective view of a light fixture with the wireless holder of FIG. 14.

FIG. 19 is another perspective view of the light fixture of FIG. 18.

FIG. 20 is an enlarged perspective view of the light fixture of FIG. 18.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” and “back,” among others are intended to refer to the orientation as illustrated and described in the Figure (or Figures) to which the components and directions are referencing.

Embodiments of the present invention are directed to wireless holders for light fixtures that support wireless communication modules having the capability to communicate wirelessly according to a Bluetooth® Low Energy (BLE), Wi-Fi®, near field communication, LiFi, 3G, or other standardized or proprietary wireless protocols. The wireless holders may be provided by either retrofitting them into existing light fixtures or providing them on new (i.e., native) fixtures. Embodiments of the present invention are directed to various ways by which to incorporate wireless holders and wireless communication modules within light emitting diode (LED) light fixtures, but it will be recognized that the invention may be embodied in light fixtures using other kinds of light sources, for example, fluorescent, incandescent, or other kinds of light sources. Embodiments of the present invention are not intended to be limited to the particulars of the light fixtures themselves.

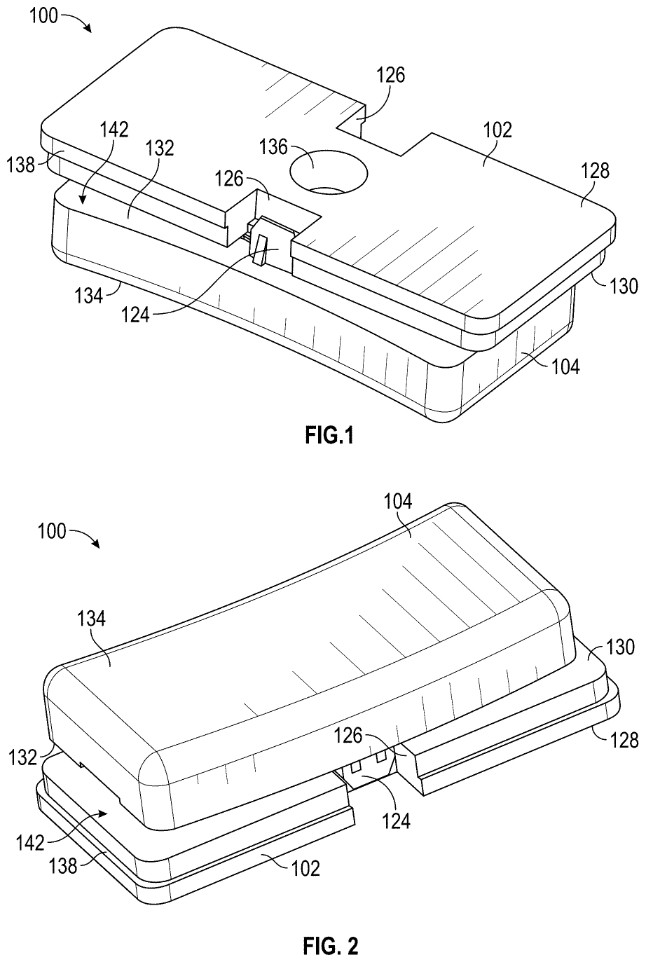

Referring to FIGS. 1-8, a wireless holder 100 for a light fixture generally includes a base 102 and a housing 104. In various examples, at least the housing 104 is constructed from a wirelessly transparent (i.e., non-metallic) material, meaning that a wireless signal can be transmitted through the housing 104. For example, the housing 104 may be made of a molded polymer such as polycarbonate, acrylonitrile butadiene styrene (ABS), or another suitable material or combination of materials. In some examples, the base 102 may also be constructed from a wirelessly transparent material, although it need not be in other examples. In the example of FIGS. 1-8, the base 102 and housing 104 both have a substantially rectangular shape. In other examples, the base 102 and housing 104 may assume any workable geometrical shapes.

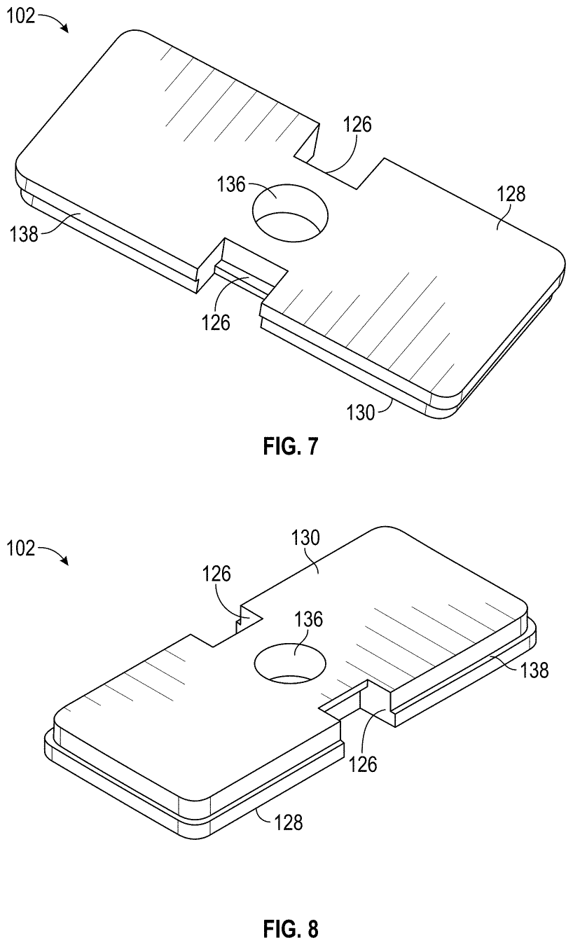

Referring to FIGS. 7 and 8, the base 102 includes a first side 128 and a second side 130 that is opposite from the first side 128. When the base 102 is assembled with the housing 104, the second side 130 faces the housing 104. A wiring aperture 136 is optionally defined through the base 102. In some optional examples, the base 102 includes a flange 138, although in other examples, the flange 138 may be omitted.

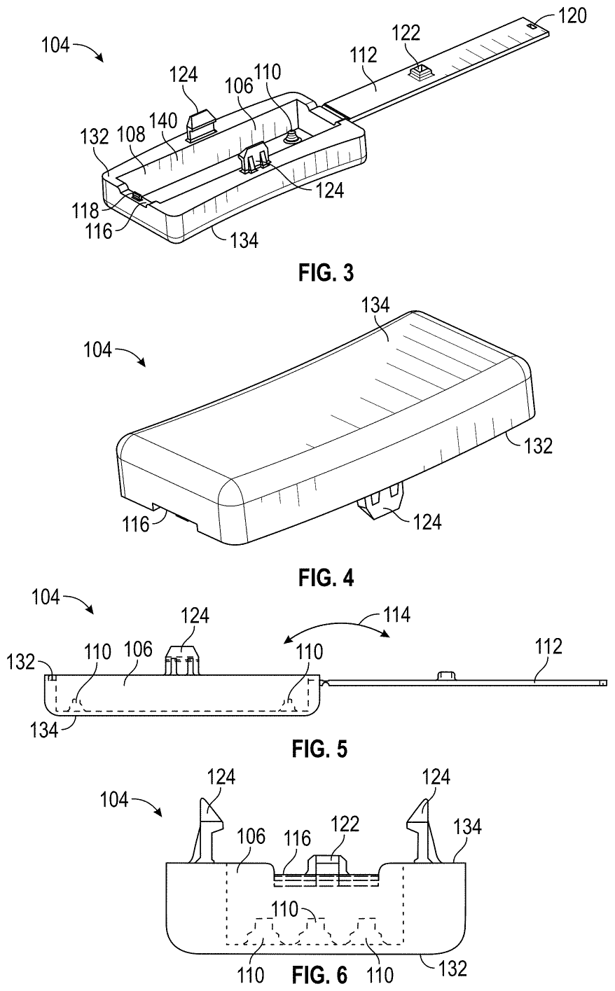

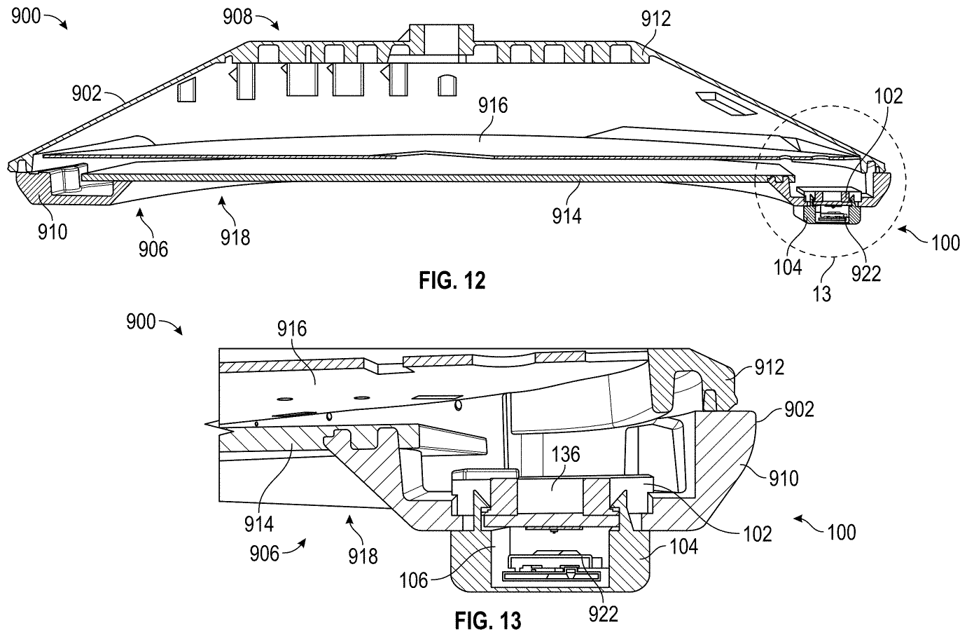

As best illustrated in FIGS. 3-6, the housing 104 includes a first side 132 and a second side 134 opposite from the first side 132. In some examples, the housing 104 defines a housing chamber 106 having a chamber surface 108. Optionally, an opening 140 to the housing chamber 106 is defined in the first side 132. In various examples, a wireless communication module (see, e.g., the wireless communication module 922 shown in FIGS. 10, 12, and 13) may be positioned within the housing chamber 106. While the housing chamber 106 is shown having a substantially rectangular shape, it could assume other geometrical shapes in other examples.

In some examples, the housing 104 includes at least one spacer 110 that supports the wireless communication module within the housing chamber 106. When positioned on the spacer 110, the wireless communication module is spaced apart from the chamber surface 108. In the example of FIGS. 1-8, the housing chamber 106 includes three spacers 110, although in other examples, any desired number of spacers may be provided. In some cases, the spacers 110 may be omitted, and the wireless communication module is positioned on the chamber surface 108 within the housing chamber 106. When the spacers 110 are provided, the spacers 110 may optionally define a mounting configuration for the wireless communication module such that the wireless communication module can only be positioned within the housing chamber 106 in a certain configuration. The at least one spacer 110 may be monolithically formed with the housing 104 as a unitary component, or it may be a separate component that is secured in the housing chamber 106 through various suitable joining mechanisms.

In various examples, as illustrated in FIGS. 3 and 5, the housing 104 includes a module holder 112 that selectively retains the wireless communication module within the housing chamber 106. The module holder 112 is movable relative to the housing 104 between a locked position and an unlocked position as represented by arrow 114 in FIG. 5. In some examples, the module holder 112 is movable relative to the housing 104 through a living hinge; however, in other examples, the module holder 112 may be connected to the housing 104 through various other suitable mechanisms such that the module holder 112 is movable relative to the housing 104.

FIGS. 3 and 5 both illustrate the module holder 112 in the unlocked position. FIG. 4 illustrates the housing 102 with the module holder 112 in the locked position, and as such the module holder 112 is not visible in FIG. 4. In the locked position, the module holder 112 may at least partially cover the housing chamber 106. In some examples, as best illustrated in FIG. 3, a portion of the housing 104 opposite from the module holder 112 optionally defines a receiving groove 116 that receives a portion of the module holder 112 when the module holder 112 is in the locked position. In various examples, a locking mechanism 118 is optionally provided to selectively retain the module holder 112 in the locked position. The locking mechanism 118 may include any of various suitable mechanisms for selectively engaging the module holder such as snap-fit connectors, clips, clasps, hooks, ribs, snaps, pins, hook and loop fasteners, combinations thereof, or various other suitable mechanisms. Depending on the type of locking mechanism 118, the module holder 112 may optionally include a complementary locking mechanism 120 that engages the locking mechanism 118.

In certain embodiments, at least one spacer 122 is provided on the module holder 112. In the example of FIGS. 1-8, the module holder 112 includes one spacer 122, although in other examples, any desired number of spacers 122 may be utilized. In some cases, the spacer 122 may be omitted. Similar to the spacer 110, the spacer 122 engages the wireless communication module within the housing chamber 106 such that the wireless communication module is spaced apart from a surface of the module holder 112. In various examples, the wireless communication module is retained within the housing chamber 106 between the spacer 110 and the spacer 122. The at least one spacer 122 may be monolithically formed with the module holder 112 as a unitary component, or it may be a separate component that is secured through various suitable joining mechanisms.

The housing 104 is removably attached to the base 102 such that the housing 104 can be selectively connected with or disconnected from the base 102. In various examples, the base 102 and the housing 104 of the wireless holder 100 may only be assembled in one configuration, which reduces or eliminates assembly error. In the example of FIGS. 1-8, the housing 104 includes a pair of locking arms 124 that selectively engage a corresponding pair of locking indentations 126 on the base 102 through a snap-fit connection. In other examples, the locking arms 124, the locking indentations 126, or both may be omitted, and the housing 104 may be removably attached to the base 102 through other suitable mechanisms such as snaps, hooks, pins, hook and loop fasteners, bolts, combinations thereof, or various other suitable mechanisms. In some examples, the locations of the locking arms 124 and the locking indentations 126 may be reversed, with the locking arms 124 being provided on the base 102 and the locking indentations being provided on the housing 104. In various examples, when the base 102 is assembled with the housing 104, the wiring aperture 136 may provide access to the housing chamber 106.

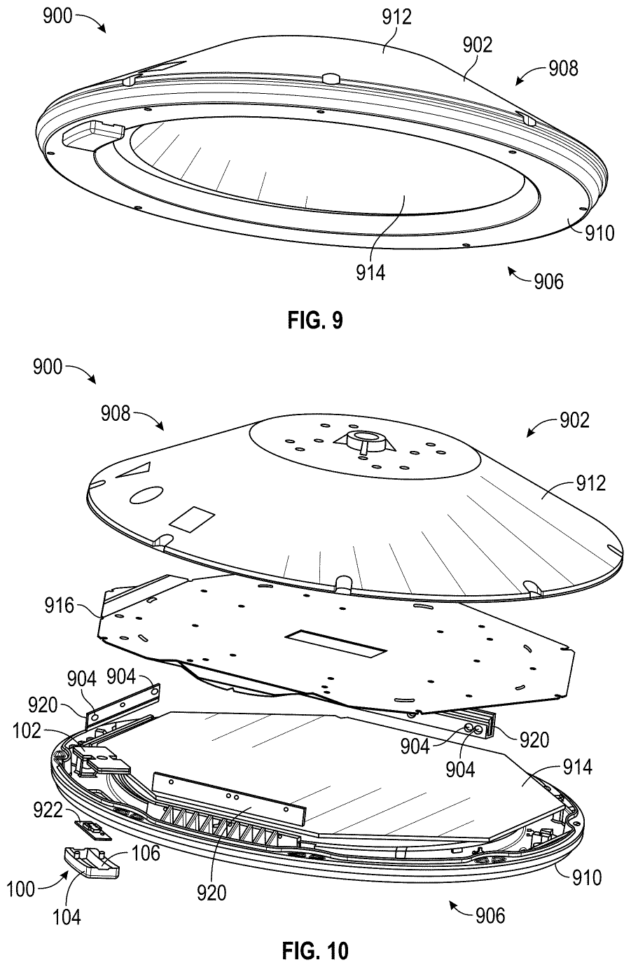

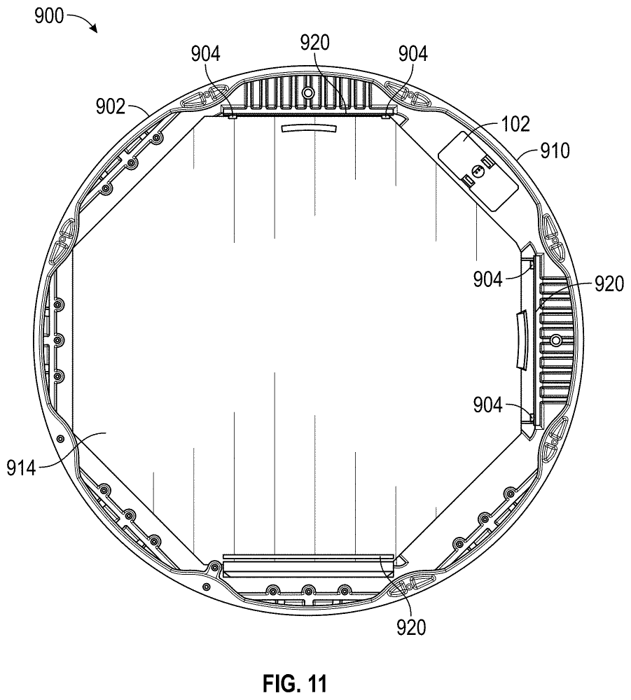

As best illustrated in FIGS. 1 and 2, when the wireless holder 100 is assembled, the first side 132 of the housing 104 is proximate to the second side 130 of the base 102. In certain examples, a gap 142 is defined between the housing 104 and the base 102. As described in detail below with reference to FIGS. 9-13, a portion of a housing of a light fixture is positioned within the gap 142 when the wireless holder 100 is assembled on the light fixture.

Referring to FIGS. 9-13, a light fixture 900 generally includes a housing 902 with one or more light sources, which may be LEDs 904 or other suitable light sources. In various examples, the light fixture 900 emits light from at least one light emitting side 906 of the fixture 900, and another side of the fixture 900 is a non-light emitting side 908 of the fixture 900 (because light is not directed toward that region of the light fixture). The light fixture 900 may commonly be mounted in or on a ceiling, a fixture support, or other suitable structure with the light-emitting side 906 facing downward into the space below, but this is not a requirement, and the light fixture 900 may be usable in any orientation.

In the example of FIGS. 9-13, the light fixture 900 is an edge-lit light fixture, and the housing 902 includes a base 910 and a cover 912. While the light fixture 900 is described as an edge-lit light fixture, in other examples, the light fixture may be various other types of light fixtures. Moreover, the geometries of the various components of the light fixture 900 shown in FIGS. 9-13 should not be considered limiting on the current disclosure.

An optic 914 (such as a lens, diffuser, or other suitable optic) and a reflector 916 are positioned within the housing 902 and adjacent to an opening 918 defined by the base 910. The optic 914, reflector 916, or both may be positioned through various mechanisms such as via snap-fitting onto the cover 912 or base 910 or through various other suitable connection mechanisms. The optic 914 can be made of any non-metallic material that permits light to exit through the optic 914, including, but not limited to, polymeric materials, glass, silicone and various other suitable materials for light distribution.

In some examples, the LEDs 904 are mounted on the housing 902 adjacent to a portion of an edge of the optic 914. In such cases, the optic 914 is also a light guide; however, in other examples, a separate light guide may be provided in addition to the optic 914, and the LEDs 904 may be positioned adjacent to at least a portion of an edge of the light guide. When the light guide is a separate component, the light guide may be made of any of various suitable materials for directing the light source emission including, but not limited to, air, polymers, glass, various transparent materials, or various other suitable materials or combinations of materials. In some examples, the light source emission from the LEDs 904 is directly into the optic 914. In other examples, an optical diverter is provided between the LEDs 904 and the optic 914 such that the light source emission from the LEDs 904 is directed to the optic 914 through the optical diverter. In further examples, the light fixture 900 need not be an edge-lit luminaire, and the LEDs 904 may be provided at other locations on the housing 902.

The LEDs 904 are shown provided on printed circuit boards 920 (“PCBs”). In some cases, the PCBs 920 with LEDs 904 are supported on the base 910, although they need not be in other examples. In the example of FIGS. 9-13, the light fixture 900 includes three PCBs 920 having LEDs 904. However, in other embodiments no PCB 920 is needed; rather, the LEDs 904 are chip-on-board LEDs provided directly on the housing 902. In further examples, any number of PCBs 920 may be provided, such as one PCB, two PCBs, or more than three PCBs. The LEDs 904 may include any of various types of LEDs including single-die LEDs, multi-die LEDs, direct current (DC) LEDs, alternating current (AC) LEDs, organic light emitting diodes, or various other suitable LEDs or combinations of LED types. White, color, or multicolor LEDs may be used. Moreover, the LEDs 904 need not all be the same color or type; rather, mixtures of different colors and types of LEDs may be used, in any workable combination.

As illustrated in FIGS. 10, 12, and 13, a wireless communication module 922 is positioned within the housing chamber 106 of the wireless holder 100. The wireless communication module 922 may include an antenna and a controller, although it need not in other examples. As mentioned previously, while the wireless communication module 922 is described as a BLE module, in other examples, the wireless communication module 922 may be various other types of modules having the capability to communicate wirelessly according to a Wi-Fi®, NFC, LiFi, 3G, or other standardized or proprietary wireless protocols.

The wireless holder 100 is removably attached to the housing 902 such that the light fixture 900 can be “smart” enabled through the wireless communication module 922. In the example illustrated in FIGS. 9-13, the wireless holder 100 is removably attached to the base 910. As best illustrated in FIGS. 10, 12, and 13, in various examples, the wireless holder 100 is attached to the housing 902 such that the base 102 of the wireless holder 100 is on the non-light emitting side 908 of the housing 902 and the housing 104 is on the light-emitting side 906 of the housing 902. In such examples, a portion of the housing 104 (such as a portion of the base 910) is within the gap 142 defined by the wireless holder 100. In some cases, the wireless holder 100 is removably attached to the housing 902 such that the first side 132 of the housing 104 of the wireless holder 100 contacts the light-emitting side 906 of the base 910 of the light fixture 900 and the second side 130 of the base 102 of the wireless holder 110 contacts the non-light emitting side 908 of the base 910 of the light fixture 900.

In various examples, the base 102 of the wireless holder 100 may be permanently attached to the housing 902 or may be removably attached to the housing 902. In some examples, the housing 104 can be detached from the base 102 such that the housing 104 and/or wireless communication module 922 can be repaired or replaced as desired without removing the base 102 or disassembling the light fixture 900.

As mentioned, the wireless holder 100 may allow for the light fixture 900 to be “smart” enabled. For example, the light fixture 900 may be controllable through a handheld wireless device such as a smartphone, to dim the light fixture 900, cause the light fixture 900 to change the color temperature of the light it emits, or to control other aspects of the operation of the light fixture 900. In addition, the base 102 and the housing 104 of the wireless holder 100 may only be assembled in one configuration, which reduces or eliminates assembly error. Positioning the wireless holder 100 such that the housing 104 is on the light-emitting side 906 of the light fixture 900 may also allow for maximum signal strength from the wireless communication module 922 to a user's device below.

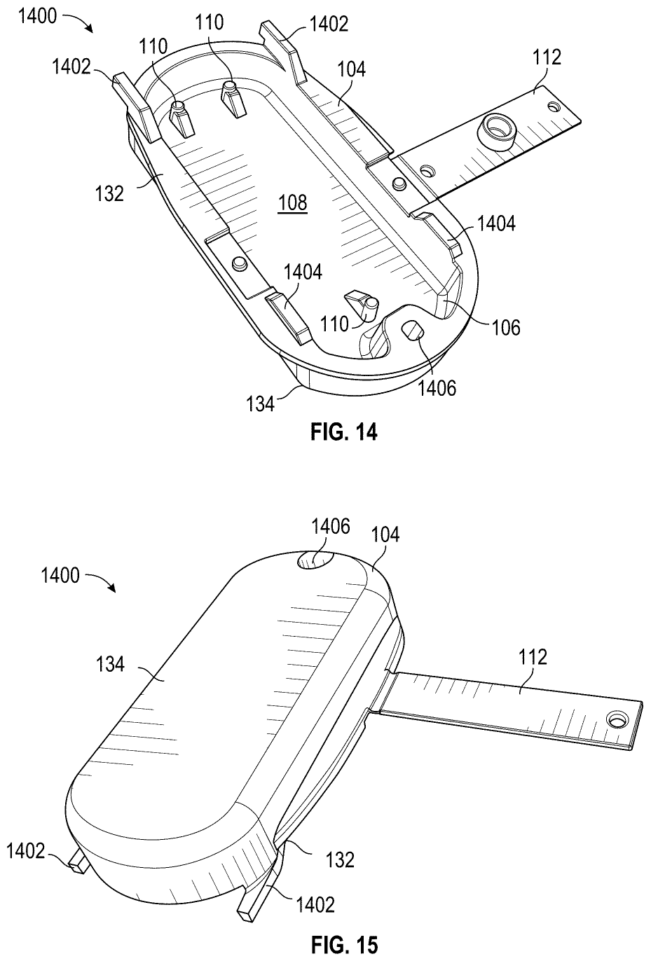

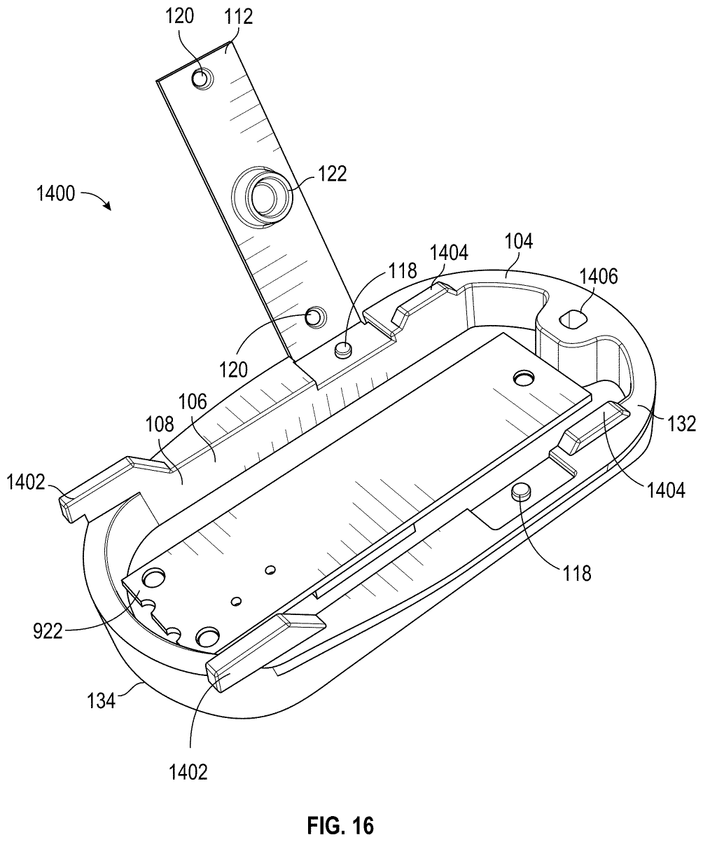

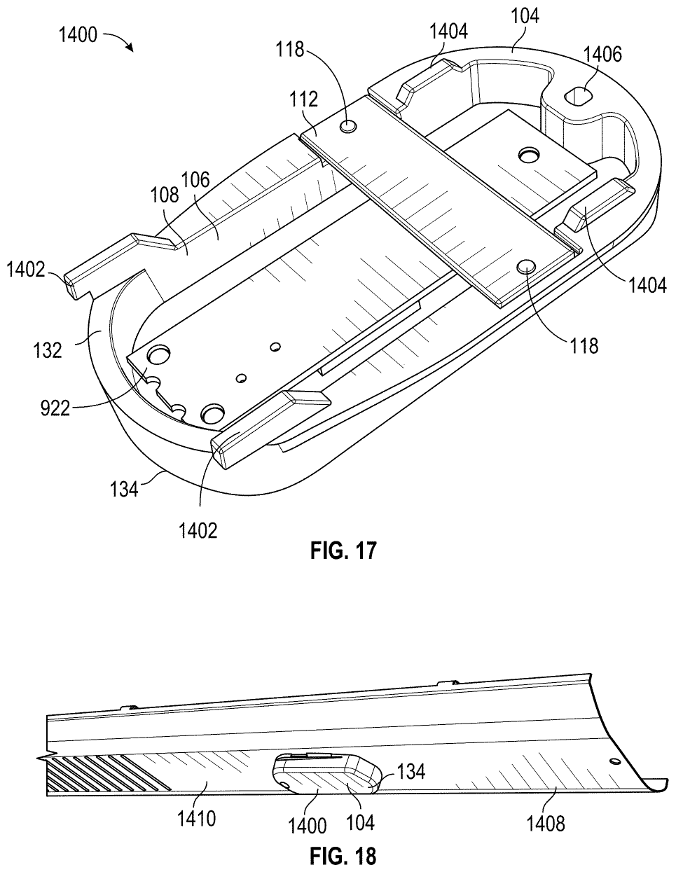

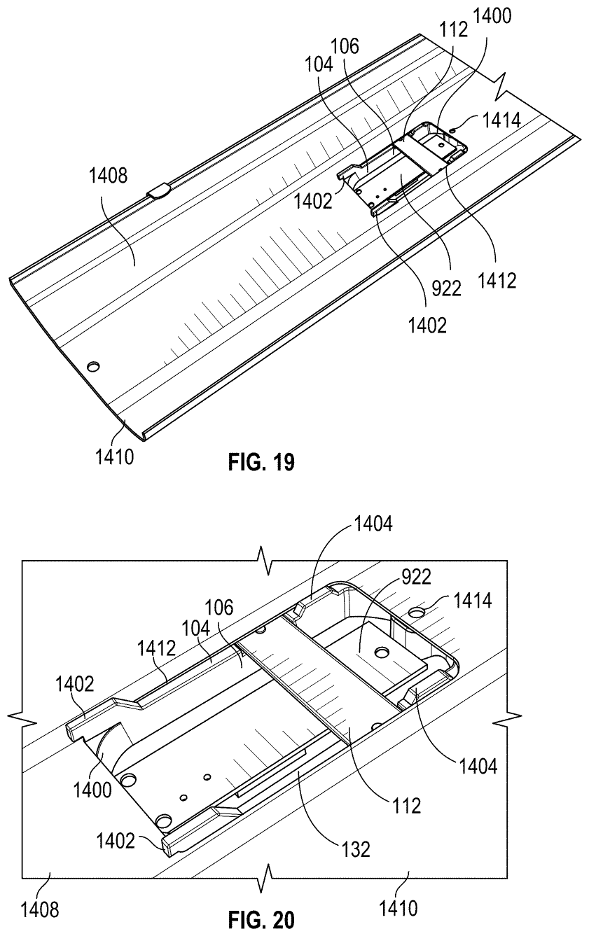

FIGS. 14-20 illustrate another example of a wireless holder 1400. The wireless holder 1400 is substantially similar to the wireless holder 100 and includes a housing 104. Unlike the wireless holder 100, the wireless holder 1400 optionally does not include a base (such as the base 102) that connects with the housing 104. In addition, compared to the wireless holder 100 where the module holder 112 spans a length of the housing 104 and/or housing chamber 106 in the locked position, the module holder 112 of the wireless holder 1400 spans a width of the housing 104 and/or housing chamber 106 in the locked position (see FIG. 17).

In various examples, as illustrated in FIGS. 14-20, the housing 104 of the wireless holder 1400 optionally includes support arms 1402, guides 1404, and/or a locking feature 1406. In certain cases, the support arms 1402 engage a housing 1408 of a light fixture 1410 by inserting the support arms 1402 into an opening 1412 of the light fixture 1410 such that the support arms 1402 at least partially overlap a portion of the housing 1408. In some cases, the support arms 1402 may allow for the wireless holder 1400 to be pivotable relative to the housing. In various examples and as best illustrated in FIG. 20, the guides 1404 may assist in the positioning and alignment of the wireless holder 1400 relative to the housing 104. In some examples, the guides 1404 may at least partially extend into the opening 1412, although they need not in other examples. The number, position, and shape of the support arms 1402 and/or the guides 1404 should not be considered limiting on the current disclosure. In certain aspects, the locking feature 1406 may cooperate with a corresponding locking feature 1414 on the light fixture 1408 such that the position of the wireless holder 1400 relative to the light fixture 1408 can be selectively fixed. In the example of FIGS. 18-20, the locking features 1406 and 1414 are apertures that are configured to receive a screw, bolt, or other suitable fastening device. In other examples, various other types of locking features may be utilized.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

1. A wireless holder for a light fixture, the wireless holder comprising:
a base; and
a housing removably attached to the base, wherein the housing comprises a first side and a second side opposite from the first side, wherein the housing defines a chamber that is configured to receive a wireless module, wherein an opening to the chamber is in the first side of the housing, and wherein the wireless holder defines a gap between the base and the first side of the housing when the housing is removably attached to the base.

2. The wireless holder of claim 1, wherein the wireless holder is configured to capture a portion of a fixture housing of the light fixture within the gap when the housing is removably attached to the base.

3. The wireless holder of claim 1, wherein the housing further comprises a plurality of spacers within the chamber.

4. The wireless holder of claim 3, wherein the spacers define a mounting configuration for the wireless module.

5. The wireless holder of claim 1, further comprising a module holder that is movably connected to the housing, wherein the module holder is configured to selectively retain the wireless module within the chamber.

6. The wireless holder of claim 5, wherein the module holder is movably connected to the housing through a living hinge.

7. The wireless holder of claim 1, wherein the housing comprises engagement arms, wherein the base comprises engagement notches, and wherein the housing is removably attached to the base through engagement of the engagement arms with the engagement notches.

8. The wireless holder of claim 1, further comprising the wireless module, and wherein the wireless module is a BLE module.

9. A light fixture assembly comprising:
a fixture housing;
a light source; and
a wireless holder configured to house a wireless module, wherein the wireless holder comprises a base and a holder housing, and wherein the wireless holder is removably attached to the fixture housing such that at least a portion of a non-light emitting portion of the fixture housing is between the holder housing and the base of the wireless holder.

10. The light fixture assembly of claim 9, further comprising the wireless module.

11. The light fixture assembly of claim 9, wherein the fixture housing comprises a fixture base having a light-emitting side and a non-light emitting side, and wherein the wireless holder is removably attached to the fixture base such that the base of the wireless holder is on the non-light emitting side of the fixture base and the holder housing is on the light-emitting side of the fixture base.

12. The light fixture assembly of claim 9, further comprising:
an optic, wherein the light source is arranged adjacent to an edge of the optic such that the light fixture assembly is an edge-lit light fixture assembly.

13. The light fixture assembly of claim 9, wherein the holder housing comprises a wirelessly transparent material.

14. A wireless holder for a light fixture, the wireless holder comprising:
a housing defines a chamber that is configured to receive a wireless module,
wherein the housing comprises a module holder that is movably connected to the housing and is configured to selectively retain the wireless module within the chamber.

15. The wireless holder of claim 14, further comprising a base, wherein the housing is removably attached to the base, wherein the wireless holder defines a gap between the base and the housing when the housing is removably attached to the base, and wherein the wireless holder is configured to capture a portion of a fixture housing of the light fixture within the gap when the housing is removably attached to the base.

16. The wireless holder of claim 15, wherein the base defines a wiring aperture that is configured to provide access to the chamber when the housing is removably attached to the base.

17. The wireless holder of claim 14, wherein the housing further comprises a plurality of spacers within the chamber that are configured to support the wireless module within the chamber.

18. The wireless holder of claim 14, wherein the housing comprises a first side and a second side, wherein the first side comprises an opening to the chamber, a support arm, and a guide, wherein the support arm is configured to overlap a portion of a fixture housing of a light fixture through an opening of the fixture housing, and wherein the guide is configured to position the wireless module relative to the opening of the fixture housing.

19. The wireless holder of claim 14, wherein the housing comprises a wirelessly transparent material.

20. The wireless holder of claim 14, further comprising the wireless module, and wherein the wireless module is a BLE module.

21. A wireless holder for a light fixture, the wireless holder comprising:
a base;
a housing removably attached to the base, wherein the housing defines a chamber that is configured to receive a wireless module, and wherein the wireless holder defines a gap between the base and the housing when the housing is removably attached to the base; and
a module holder that is movably connected to the housing, wherein the module holder is configured to selectively retain the wireless module within the chamber, and wherein the module holder is movably connected to the housing through a living hinge.
